(19) United States
(12) Patent Application Publication
(10) Pub. No.: US 2018/0236299 A1
(43) Pub. Date: Aug. 23, 2018

(54) Sleeve Grip Applications

(71) Applicant: Wesley Warriner, Atlantic City, NJ (US)

(72) Inventor: Wesley Warriner, Atlantic City, NJ (US)

(21) Appl. No.: 15/440,256

(22) Filed: Feb. 23, 2017

(51) Int. Cl. A63B 21/00; A63B 21/072; F41C 23/16; F41C 23/14; E06B 9/326

(52) U.S. Cl. CPC A63B 21/4035; A63B 21/0724; E06B 9/326; F41C 23/14; F41C 23/16

(57) ABSTRACT

A rod and sleeve grip assembly provides an additional pivot point between the human limb and the component being gripped that a provides a more natural-biomechanical movement that reduces and/or prevents stress and strain on the joints being used as energy is transferred between the axle and sleeve assembly. Thus, energy transfer happens between the rod and sleeve setup which takes away stress and strain from the human joints. This concept can be used on everything that we grip and hold onto which allows natural movement and establishes an extra pivot point for energy transfer. A barbell assembly includes an axle having two connection holes respectively defined in two ends thereof with three rotating sleeves that revolve around that axle, and two collars are respectively mounted to the two ends of the axle and sleeve assembly. The two collars rotate around the sleeves while the three sleeves rotate around the axle.

### BACKGROUND

### Prior Art

The following is a tabulation of some prior art that presently appears relevant:

U.S. Patents

| Patent Number | Kind Code | Issue Date | Patentee |
|---|---|---|---|
| D583883 | S | 2008 Dec. 30 | Thomas |
| 6,770,016 | B1 | 2004 Aug. | Anderson |
| 7,131,938 | B2 | 2011 Jun. | Cao |
| 2003/0232705 | A1 | 2003 Dec. | Harms |
| 2007/0249475 | A1 | 2007 Oct. | Cao |
| 2009/0270233 | A1 | 2009 Oct. | Cao |
| D291, 612 | N/A | 1987 Aug. 25 | Inui |

The present invention relates to practical applications of the rod and sleeve grip which can be used in many fields, industries, etc. Depending on the application, different types of materials/metals can be used. The key discovery is the rod/sleeve concept takes strain and stress away from the joints that are used because energy transfer occurs in between the rod and sleeve assembly. In other words, anything that a person grabs to exert a force or force is exerted by the component, object, system, etc. Thus, energy transfer is now more efficient while strain and stress is being relieved from the joints which now incorporates more stabilizer muscles that most people don't use daily in the current existence. Regardless of application, this is allowing natural movement of the joints used which rotates in the direction of the applied force. Therefore, the longevity of the joints will be increased because the hands, wrists, and elbows can revolve/rotate around the component, weight, handle, etc. into a safer and more practical biomechanical movement and position. Nowadays, humans just grip/grab onto whatever it is to exert force to maneuver it around the joints which induces stress and strain on the joints. For example, humans don't grab solid-cylindrical style door handles the same way. In other. The door handle itself isn't gripped on the same spot, force isn't exerted at the same angle, and the area where a person stands in reference of the door is never in the same either. This can be used by every person in whatever task they do from seasonal yard work equipment to athletes, gyms, physical and occupational therapy institutions, hospitals, luggage bags, bicycles, briefcases, etc. The rod and sleeve setup is basically a way transfer energy in another area within that system. One of many embodiments is a revolutionized barbell assembly, and more particularly, a barbell assembly consisting of a rod with three rotatable sleeves which revolve around that rod in between the parts thereof. Individuals who exercise with weights sometimes develop wrist and elbow injuries, pain, and aches. An individual's comfort of each hand grip is going to be different because were humans and were are not symmetrically perfect. In other words, as both hands are gripped simultaneously onto the existing 1.125″ barbell rod assembly, usually one hand is over gripped more than the other which is felt through their conformity. It is an unobserved, unnoticed, and unintended human error. These could be causing aches and pains in the hands, wrists, elbows, and possibly shoulders without knowing it. The present invention improves upon the prior-art device by making the following changes: one smooth-surfaced rod/axle, approximately 0.565″ in diameter and 7′ in length, consisting of three rotatable mounted sleeves which revolve around that rod. The middle sleeve, approximately 1.125″ (O.D.), 0.560″ (I.D.), and 16″ in length, will rotate along the limbs to reduce friction and to prevent scrapes and cuts. The two outer sleeves, both approximately 34″ in length consisting of the same inner and outer diameters as the middle sleeve, are mounted onto the axle to the right and left side of the middle sleeve. The reason that the diameter of the rod is almost equal to the inner diameter of the sleeves is to keep things in proportion within the assembly when external force is applied as well as warp prevention of components. To generalize it all, if you take the collars off the existing barbell assembly, what's left remaining is just a 1.125″ thick solid rod/axle. The present barbell invention embodiment is revolutionized based on the 1.125″ material used to create the revolving barbell invention previously mentioned consisting of a rod with three sleeve components which are the improvements. This will help solve this problem because the rod/sleeve assembly will rotate into a state of equilibrium which maximizes weight distribution, energy transfer is directly in between the axle and sleeve. Exertion on the whole human body as a unit is more precise, symmetric, and proportionally balanced during the lift. It may help reinforce symmetry in areas where one is dissymmetric. This can drastically impact society and the way we do things in terms of anything being gripped to exert force to move or be forced to move by the system/component. Conceptually, its similarity to the plastic handle on the bucket, but in terms of three rotating sleeves rotating about an axle. This concept could be applied and used in injury prevention in any form. Any apparatuses can use this in any facility used in areas based on the previously mentioned logic. This would include all present existing objects, components, and handles with a solid shape that can be converted into an axle/sleeve or possibly an external hand-held sleeve alone to mount over those existing solid rod-like apparatuses, exert and/or be exerted by force, and then simply slide open the hand-held sleeve tool. The irony about this simple concept is that it's used by mechanics by sliding a pipe over a ratchet handle to increase leverage to loosen a bolt, but most don't realize the main underlying benefit of that trick is the reduction of pressure off of the joints. It's unfortunate and disappointing that the present invention concept application is one of many existing simple concepts used in a few areas, but aren't used in many areas where needed, thus, would be more cost-effective, simple, and logistic while bypassing the inevitable, technological errors.

The present invention intends to provide a barbell assembly which improves the shortcomings of the conventional barbell assembly.

### SUMMARY

The present invention relates to applications where the rod and sleeve setup will be most beneficial for joint health in all areas, fields, tasks, and activities where pressure can be reduced greatly to preserve and use in our elderly years. In accordance, the present invention relates to a revolving barbell assembly embodiment consisting of three rotating sleeves which rotates around the axle with two connection holes respectively defined in the two ends thereof with two collars that are mounted and connected at the end of the axle holes. The 16″ middle sleeve and two 34″ outer sleeves have the same inner and outer diameters. The other two outer sleeves are equal in length while mounted to the left and right side of the middle sleeve on the axle.

The present invention will become more obvious from the following description when taken about the accompanying drawings which show, for purposes of illustration only, a preferred embodiment in accordance with the present invention.

### DRAWINGS

### Figures

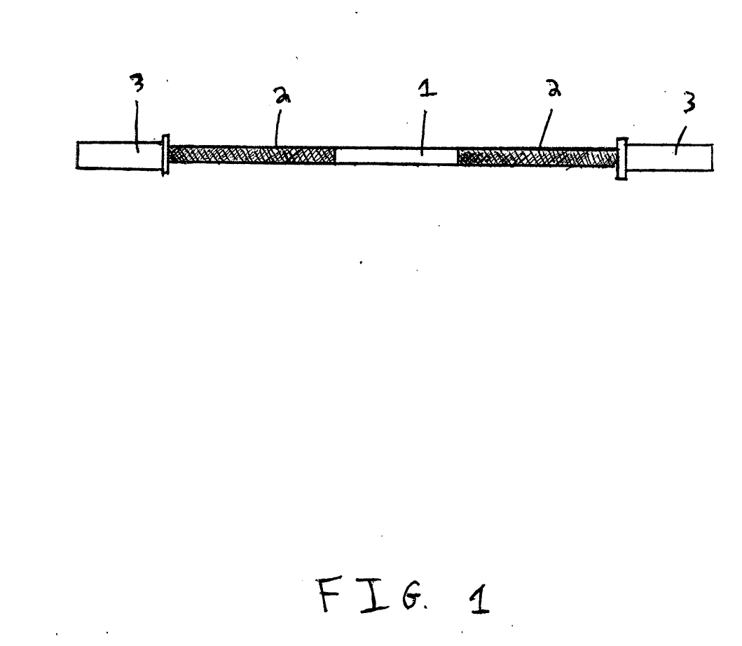

FIG. 1 is a perspective view to show the barbell assembly of the present invention;

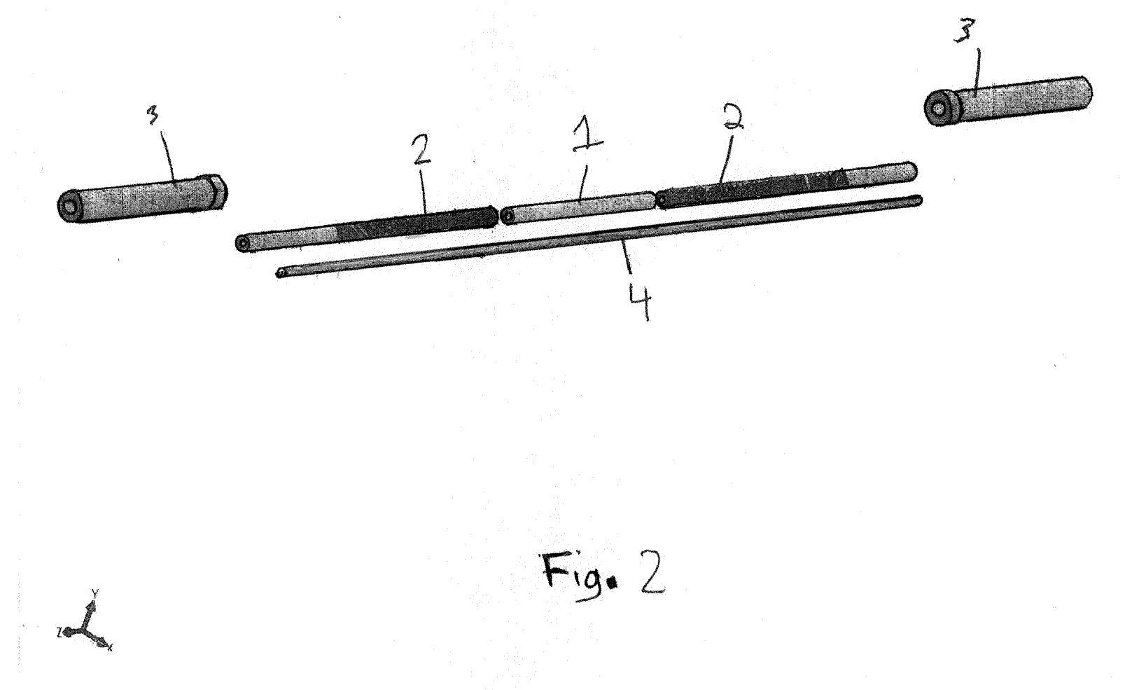

FIG. 2 is an exploded view to show the barbell assembly of the present invention;

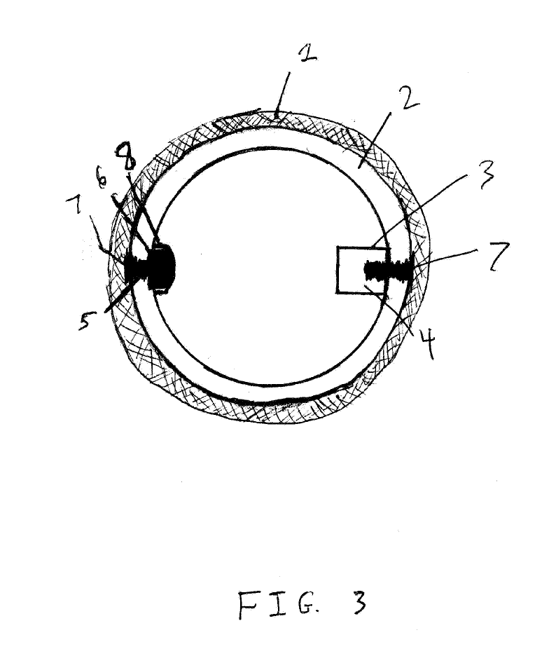

FIG. 3 is a cross sectional view to show the assembly of the present invention of the sleeves and axle. They are connected to the present invention which is where the energy transfer takes place.

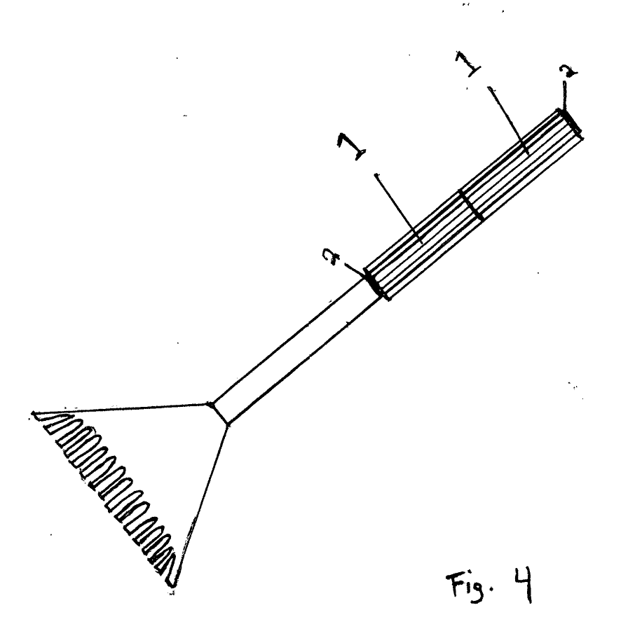

FIG. 4 is a perspective view to show the sleeve-grip assembly of the present invention.

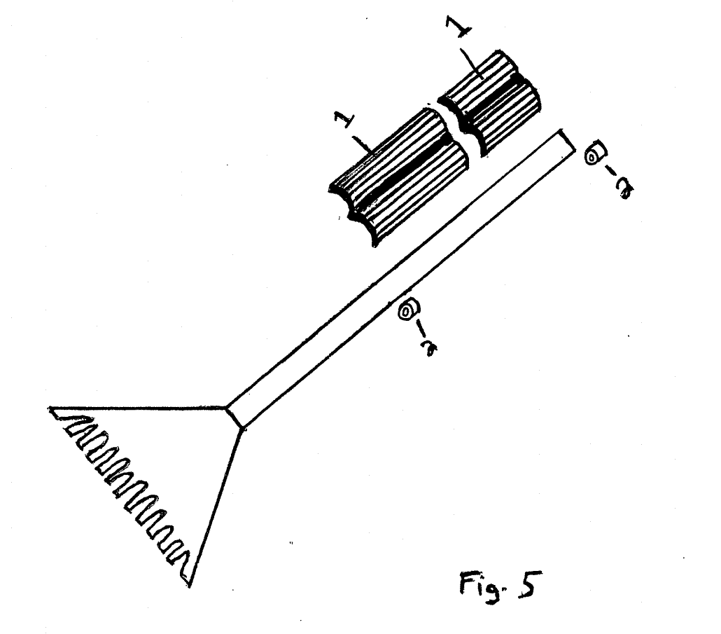

FIG. 5 is an exploded view to show the sleeve-grip assembly of the present invention.

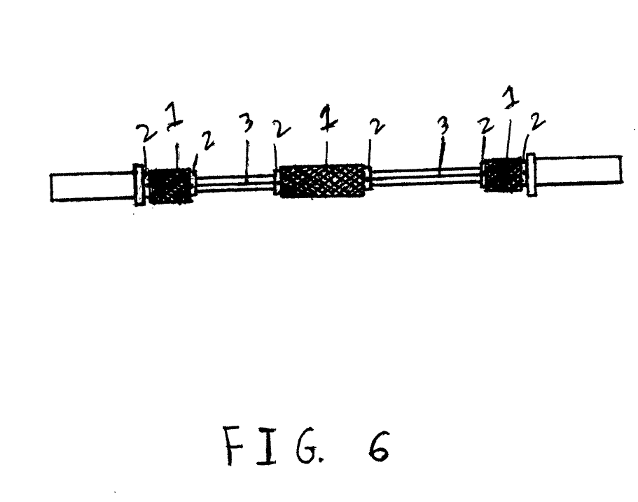

FIG. 6 is a cross sectional view to show the sleeve-grip assembly of the present invention.

### DETAILED DESCRIPTION

### FIGS. 1 to 6

### First Embodiment

Referring to FIGS. 1 to 6, the barbell assembly of the present invention compromises an axle 4 having three rotating sleeves 1 to 2 respectively defined on the axle 4 thereof. The two collars 3 are respectively mounted to the two ends of the axle 4 and sleeves 1 to 2. As shown in FIG. 3, the connection of the axle 4 and sleeves 1 to 2 is where energy transfer takes place when a force is exerted, thus, taking strain and stress off the wrists when held. As show in FIGS. 4 to 5, the sleeve-grip assembly of the present invention compromises two pivotal sleeve grips 1 and two rubber stoppers 2 respectively defined on the rake handle thereof.

While we have shown, and described the embodiment in accordance with the present invention, it should be clear to those skilled in the art that further embodiments may be made without departing from the scope of the present invention.

### CONCLUSION, RAMIFICATION, AND SCOPE

Accordingly, the reader will see that the revolving barbell of the various embodiments can be used in everyday practical applications where a hand grips onto an axle and/or handle-like component to take the strain and stress off the wrists to increase the longevity of those limbs, but also for recovery and rehabilitation purposes. In applications where both hands are gripping or holding onto a component or piece of equipment consisting of two components to be held at the same time, this also makes symmetric exertion on the human body. While the above description contains many specificities, these should not be construed as limitations on the scope of any embodiment, but as exemplifications of various embodiments thereof. Many other ramifications and variations are possible within the teachings of the various embodiments.

For example, the axle and sleeve assembly can be used on the pull-up, dip-bar, wheel barrels, rakes, bikes, briefcases, traveling luggage bags, two-sleeved training devices for sports equipment that uses one or both hands. Again, this would increase an athlete's hand, wrist, and elbow longevity while preventing injury of use of the limbs being used. Basically, anything that a person grabs onto, this rod and sleeve setup will benefit anyone. Once again, if you think of the plastic handle on the bucket assembly, this concept will be can used in everything else that we must grip, hold, and/or grip and exert force.

Thus, the scope should be determined by the appended claims and their legal equivalents, and not by the examples given.

I claim:

1. A rod and sleeve grip assembly provides an additional pivot point between the human limb and the component being gripped. This provides a more natural-biomechanical movement that helps reduce and prevent stress and strain on the joints being used as energy is transferred between said assembly.

2. The rod and sleeve assembly of claim 1 wherein said pivot point could be part of the solution to our current arm-related joint problems. This could increase longevity and possibly eliminate those long-term aches from our present to future generation of humans.

3. The sleeve grip assembly provides pivotal movement on military weapons for soldiers for efficient and faster weapon turn to target shot as well as in situations where both hands can rotate to be hold in tight/awkward spots.

4. The sleeve grip assembly provides separation to prevent entanglement/knots that occur with window blinds.

3. The rod and sleeve assembly of claim 2 wherein said pivot point has multitude applications/areas where said grip and force is applied and/or exerted by the component/system.

4. A barbell assembly comprising: an axle having two connection holes respectively defined in two ends thereof; three sleeves rotatably mounted onto the axle, two collars respectively mounted to the two ends of the axle and sleeves.
